(19) United States
(12) Patent Application Publication
(10) Pub. No.: US 2007/0252809 A1
(43) Pub. Date: Nov. 1, 2007

(54) System and method of direct interaction between one or more subjects and at least one image and/or video with dynamic effect projected onto an interactive surface

(75) Inventor: Alessandro Valli, Firenze (IT)

Correspondence Address: John S. Egbert;Egbert Law Offices, 7th Floor, 412 Main Street, Houston, TX, 77002, US

(73) Assignee: IO SRL, Treviso (IT)

(21) Appl. No.: 11/391,724

(22) Filed: Mar. 28, 2006

(51) Int. Cl. G09G 5/00

(52) U.S. Cl. 345/156; 348/744

(57) ABSTRACT

The system of direct interaction between one or more subjects and at least one image and/or a video with dynamic effect projected onto an interactive surface includes an interactive station. The interactive station includes an integrated apparatus for the acquisition and processing of the information detected in the interactive area, and a covering shaped like a box able to be fixed on a surface perpendicular with respect to the interactive area in which the natural action of the person and the interaction between the person and at least one image projected by the projector is carried out. The interactive station of the wireless type incorporates a PC control unit, infra-red ray generators, and at least one video camera with a firewire card. The method of direct interaction includes managing the interactive system, managing networking and physical alignment, selecting interactive effects, tracing statistics, and performing a cluster function.

This invention relates to a system and method of direct interaction between one or more subjects and at least one image and/or video with dynamic effect projected onto an interactive surface.

### DOMAIN OF THE INVENTION

The invention finds particular, though not exclusive, application in the sector of interactive systems that require hardware and software components, to make environments frequented by the public more captivating and agreeable, like for example, shops and public businesses in general, or like a visual terminal, integrated into a media network, managed in a centralized way, for the visualisation of contents with advertising means.

Within internal architecture, such as the furnishing of shops can be, but also other environments intended however for the frequentation of public, there is, at present, a strong tendency to characterize the environment itself, diversifying it as much possible from the existing, sometimes giving the same, the ability to communicate messages that the public sensorially notices in different ways. So, for example, it is possible to intervene on non-conventional furnishing, attributing aesthetic values intrinsically liked to the business that is conducted inside the environment. To give a concrete example, it is reasonable to expect that in a shop where nautical clothing for is marketed, the furnishing recalls the sea, so, as a consequence, the chromatic shades of the furniture as well as the design of the furniture itself, should recall the sea or the water and its sensations. In other cases still, visual and/or audio messages are often given to these characteristics more or less present in the environment, with well-known marketing techniques, which can provide repeatable messages, for example advertising, or only with informative aims, administrated by the help of conventional visual and/or audio techniques. Often, it is frequent to see information copied onto paper of average and large sizes, reproduced on furniture, on the ceiling or on the floor, just like plays of light which interact with static images and which are reproduced on conventional supports. In the same way, sometimes the emission of video-sonorous messages can be observed, which give an indication of the innovation present or serve as an aid like a shopping guide or even just for simple information. Finally, a wide diffusion of conventional displays are observed, where even TV images are reproduced, as are known projectors, able to transfer images onto generally flat surfaces, which are also equipped with audio functions.

### STATE OF THE ART

The need to introduce new communication techniques has caused some businesses of the sector to outline more evolved solutions, above all with the aim of a greater interaction with the recipient of the information.

In this setting, the function “motion capture” is known, able to define technically, by means of suitable apparatus interacting together, the ability to detect the position and the movement of the human body and to transfer the relative data to be processed in a conventional PC.

In WO2004/055776 (Bell) an interactive directed beam system is described. In one solution, the system includes a projector, a computer and an image acquisition apparatus. The image acquisition apparatus is configured to view and capture information in an interactive area. The captured information may take various forms, such as an image and/or audio data. The captured information is based on actions taken by an object, such as a person, within the interactive area. Said actions include, for example, natural movements of the person and interactions between the person and an image projected by the projector. The information captured by the image acquisition apparatus is therefore sent to the computer to be processed. The computer starts one or more processes to extract certain information, such as, the relative location of the person within the interactive area for use in controlling the projector. Based on the result generated by the processing process, the computer directs the projector to adjust the projected image in accordance with the information received. The projected image can be moved anywhere within the confines of the interactive area.

Also U.S. Pat. No. 5,534,917 (MacDougall) proposes a video image control system. In this case, a video camera is provided, which acquires information from a field of view and generates video signals, which represent the captured image of the field of view. The video signals are processed by a digitizer, which them converts them into digital information. The digital information is therefore transferred to a computer and stored. The computer therefore, starts a function and, on the basis of the stored digital information and the bitmaps stored in the computer memory, this associated with predefined areas of interest in the field of view of the video camera, determines when a subject in the field of view is placed so that at least one portion of the subject is located in an area of interest. If the person is perceived as coming within an area of interest, the computer determines the proportion of the area of interest obscured by the person and generates a control signal having a value dependant on the proportion of the area of interest obscured by the person. The control signal is therefore applied to a dependent control device. In addition, the computer provides signals to view the superimposed captured image or another image, which shows an area of interest within the field of view, providing visual feedback to the subject. In this way, the subject is capable of controlling the operation of the dependent control through movements within the field of view of the video camera.

In conclusion, interaction systems between a subject and a projected image are reasonably well-known, which provide:
A video camera, a projector and an image processing PC;
The information captured is based on actions performed by an object, such as a person, within the interactive area. Said actions include, for example, natural movements of the person and interactions between the person and an image projected by the projector.

### DISADVANTAGES

The applicant is of the opinion that the main disadvantage in reference to the abovementioned solutions consists in the fact that the well-known systems do not allow the optimization of the interactive function between the natural movement of the person and the image projected by the projector; secondly, such systems do not seem sufficiently flexible in defining the sizes and the shape of the area of the interactive surface in which subjects can interact and, moreover, are unsuitable to a fast and effective personalization. The well-known systems, are also of complex management and are not able to be implemented with other functions and/or effects.

Lastly, one final aspect relates to the fact that the stated solution is inadequate to manage a multiple number of interactive stations, fundamental characteristics in configuring an interactive station network in media channel mode.

Hence, the need for companies, particularly of the sector, to identify more effective alternative solutions, with respect to the solutions in existence up to now.

The aim of this invention is also to avoid the described disadvantages.

### BRIEF DESCRIPTION OF THE INVENTION

This and other aims are reached with this invention according to the characteristics included in the claims, solving the problems shown by means of a system and a method of direct interaction between one or more subjects and at least one image and/or a video with dynamic effect, projected onto an interactive surface, by means of an interactive station including an integrated apparatus for the acquisition and processing of the information detected in the interactive area, and a covering shaped like a box able to be fixed on a surface perpendicular with respect to the interactive area in which the natural action of the person and the interaction between the person and at least one image projected by the projector is carried out, said interactive station of the wireless type which incorporates a PC control unit, infra-red ray generators, at least one video camera with a firewire card.

The use of a multitude of interactive stations (Cluster) allows, by means of suitable software modules, to create a single (in terms of homogeneity and continuity of the interaction mode) interactive surface of the shape and sizes desired. The software module of soft edge blending (SSEB) is particularly useful in this type of configuration, which allows to gradually manage (to the user's taste) the overlapping (overlap) of the images or the video contiguously projected in order to create in the subjects, the illusion of a single interactive surface.

The interactive station is integrated with an administration system (Administration Panel) that allows the complete management by network in Stand Alone mode (a single station) or in Networking mode (more interactive stations subdivided by groups and synchronised together), by means of suitable user interface.

Through the Administration Panel the user operates with:
the selection of the desired interactive effect from a pre-existing library of effects (Effects Library), able to be updated via internet with new effects which will be conceived and realised
the setting of the parameters which characterize each interactive effect to one's taste
the selection of the contents (images or video) to be associated to the interactive effects, creating a Preset (interactive effect+content) reusable as desired and able to be saved in the appropriate library (Preset Library)
daily planning and with desired times of the Preset (effect+content) created, giving the possibility to realize real programming of contents (Scheduling)
the setting of a network of interactive stations of which it will be possible to remotely manage the contents and the programming (Networking)
the renewal and the purchase of new licenses regarding the interactive effects (License Admin-unlocking code)
the viewing and printing of the report regarding the quantity of interaction produced by visitors for each interactive station (Statistics)
the cluster function, simultaneously managing a multitude of synchronized interactive stations to create a wider interactive surface of the shape and sizes desired (Cluster)
   AIMS

In this way, through the considerable creative contribution, the effect of which allowed to achieve considerable technical progress, some aims and advantages are reached.

A first aim, has understood to optimize the interactive function, significantly improving both the dynamic effect of the image projected onto the interactive area, and also the result, from the sensorial viewpoint, perceptible of the interaction between the person and at least one image projected by the projector, assisted by audio function and/or with the possible integration of essence diffusers.

A second aim, made possible by the participation of a multitude of video projectors and video cameras, relates to the possibility of establishing an interactive area not necessarily defined by conventional edges of a quadrilateral geometric figure, but being able to be represented like a complex interactive area, which, in one case, can assume the shape of an object, the edge of which an irregular profile.

A third aim has been that of realizing a system which has the ability to integrate a potentially infinite number of interactive stations, entirely manageable by remote, both for group logics and also individually: in this case the single interactive station is configured as an intelligent advertising instrument, the contents of which can be updated and scheduled by remote.

In fact, the creation of a network of interactive systems has been made possible in such a way, which are synchronized together, are able to be updated and controlled in real time via network from a centralized station.

These characteristics make it an extremely flexible instrument, such as to satisfy the necessary specifications of use as a terminal of advertising programming in a network of interactive systems operating in public spaces (Media Channel).

A fourth aim, has consisted in realizing a compact, integrated interactive station, with good technological content, easily able to be customized and provided with a good degree of flexibility due to its ability to be easily adapted on the basis of multiple destinations.

These and other advantages will appear from the following detailed description of a preferred solution with the aid of the enclosed schematic drawings, whose details of execution are not to be considered limitative but only illustrative.

### CONTENT OF THE DRAWINGS

FIG. 1, represents a flowchart of the logic of the PC control unit of the interactive station;

FIG. 2, represents a flowchart relative to the access to the properties of the images contained in the library present in the logic of the PC control unit of the of the interactive station;

FIG. 3 represents a plan (plan view) of one possible installation of more interactive stations in Cluster mode

FIG. 4 is a view in axonometry of the electric/electronic equipment support device;

FIG. 5 is a sectional view of the interactive station;

FIG. 6 is an axonometric view from the bottom of the interactive station;

FIG. 7 is a view from the bottom of the interactive station.

### EMBODIMENT OF THE INVENTION

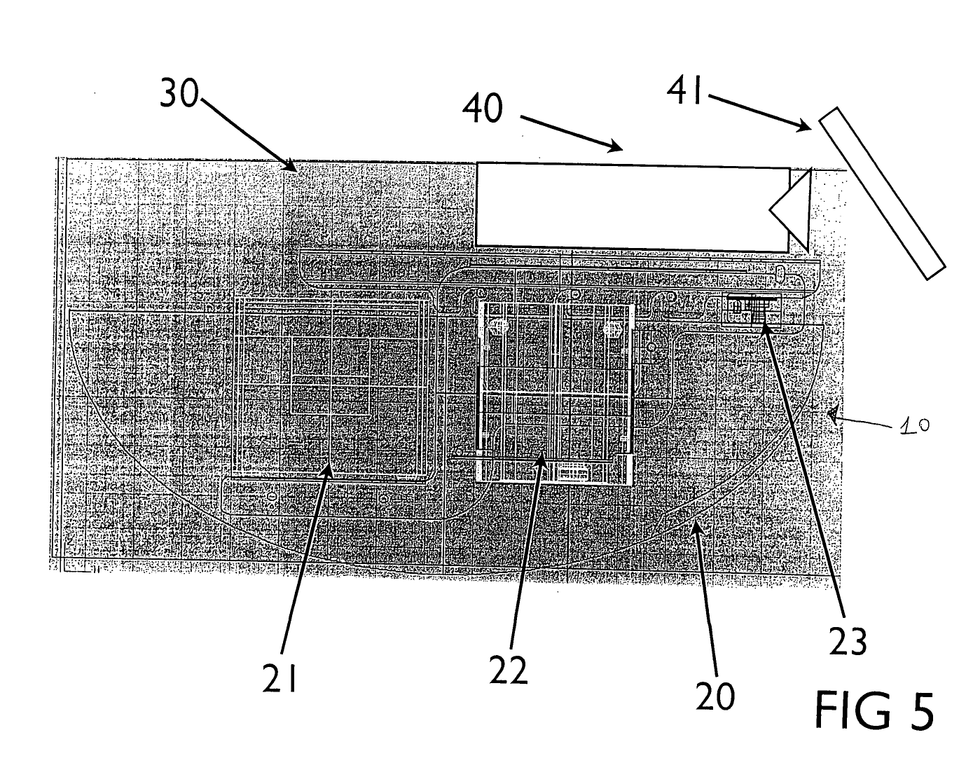

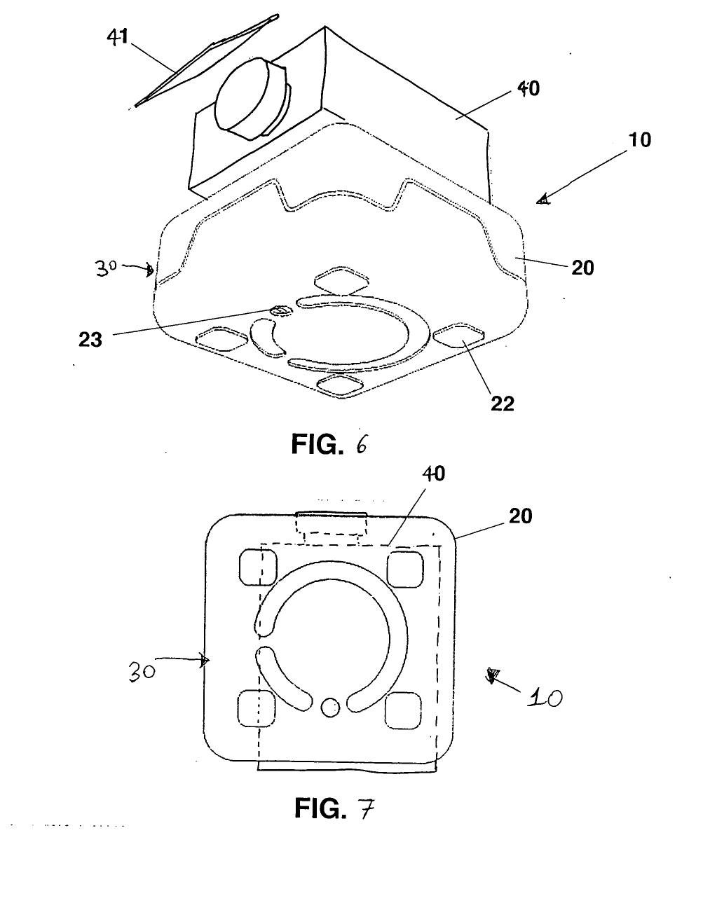

With reference also to FIGS. 5, 6 and 7, it is observed that the system and method of direct interaction, object of this invention, requires at least one interactive station 10, conceived in such as way as to be resistant, but light enough to simplify installation, and moreover, easily able to be customized by means of the covering 20 shaped like a box. It includes at least one integrated apparatus for the acquisition and processing of the information 30, which is part of the interactive station 10 and at least one video projector 40, connected to said integrated apparatus for the acquisition and processing of the information 30.

The interactive station 10, in one possible embodiment of the invention, which includes an electric/electronic apparatus support device 100, is fixed on the ceiling of an environment. It is positioned in such a way as to be substantially perpendicular with respect to an underlying interactive area, which, in this case, is identified on a surface able to receive the projection of images using a layer of treadable material, which can consist of any non-reflecting, opaque white surface. In principle, the physical structure that sustains the interactive station consists of different components, which are able to be easily assembled and enclosed by a covering 20 shaped like a completely customizable semi-spherical box. The physical structure integrates the following Hardware components:
a PC control unit 21,
infra-red ray generators 22,
at least one video camera 23 with a firewire card
an audio output
a possible essence diffuser device

Between the integrated apparatus for the acquisition and processing of the information 30 and the ceiling, the video projected 40 is interposed, which, by means of a suitable reflecting plate 41, sends the images projected onto the underlying interactive projection surface.

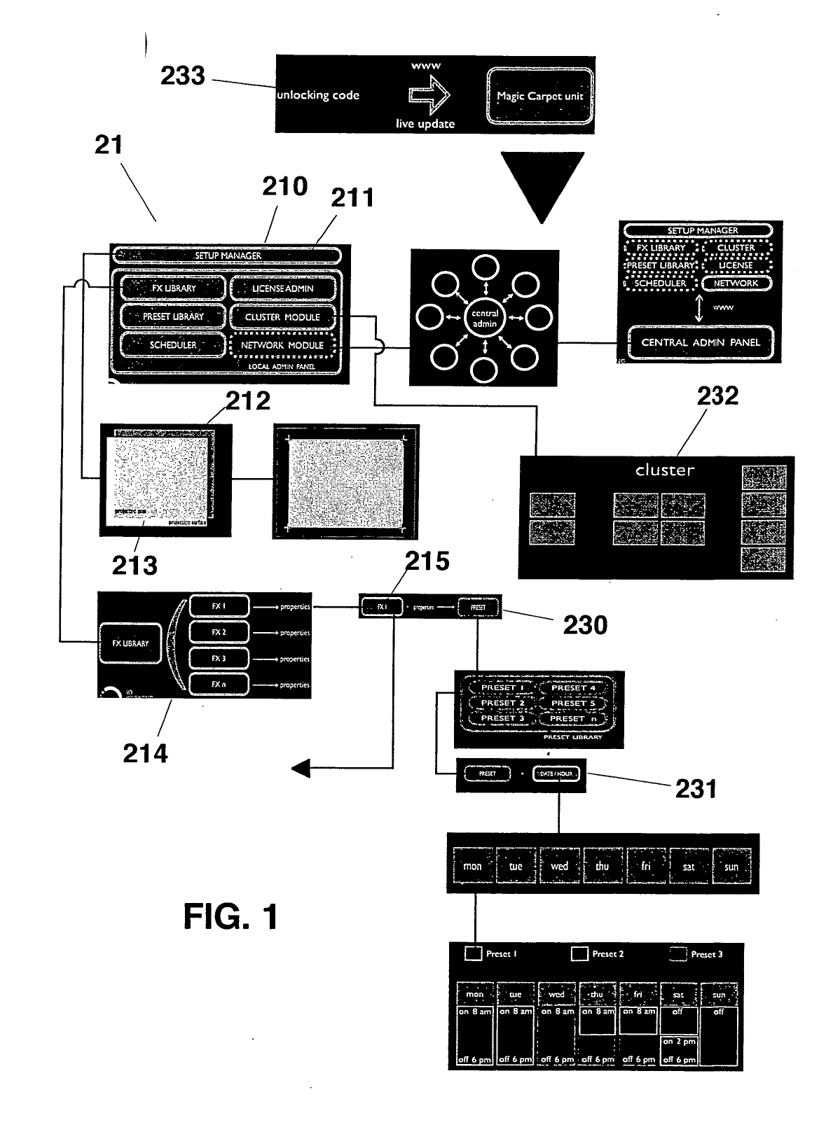

In more detail, the PC control unit 21 of the interactive station 10, (see FIG. 1) provides a logical architecture 210 which provides several functions.

The first is the setup manager 211, which allows the calibration of the system during installation.

Because of the specific physical characteristics of the environment in which the interactive station is installed, often the start-up of the system can produce the non-perfect coincidence of the projection area 212 with respect to the desired projection surface 213. In this case, the function 211 allows the alignment of the projection area 212 with respect to the underlying projection surface 213, a function which is simplified by the fact that the corners of the projection surface 213 are marked by the video camera 23: In substance, the setup manager 211 allows, once the physical installation of the interactive station has finished, to exactly align the interactive projection area, satisfying, by means of the support of the proprietary software, the unpredictable environmental limitations that can make installations of the interactive structure difficult.

Moreover, the setup manager 211 allows the auto-calibration of the “shutter” and “brightness” parameters of the camera, in relation to the specific conditions of environmental light and the width of the delimited interactive area.

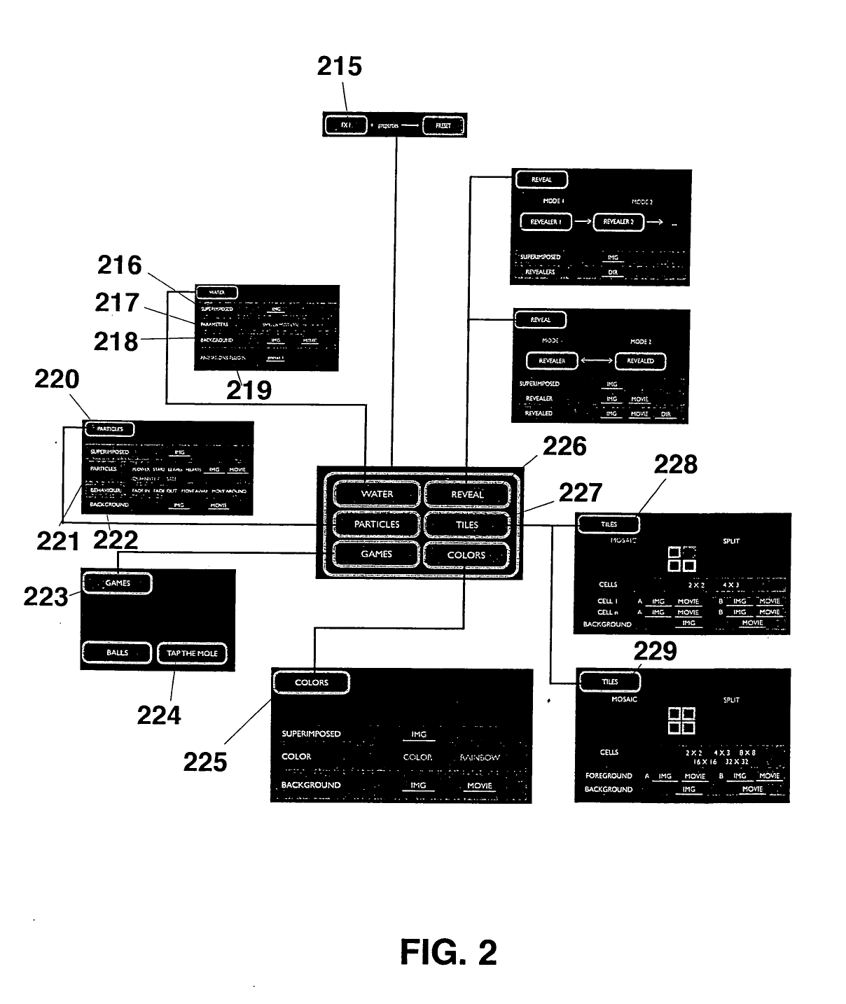

The effects library function (Fxs Library) 214 consists of a predefined file, where a series of interactive effects are stored, identified as Fx1, Fx2, Fxn 215, 220, 223 each having a different motif. For example, Fx1 215, can consist of an interactive effect conventionally defined as “water” (see FIG. 2), which creates the illusion of walking over a liquid surface for those who walk in the interactive area. With regard to this effect, the user can intervene both modifying its properties (in this specific case, the intensity of the “water” movement effect), and loading an imagine (.jpg) or a video (.avi) as a background.

The other interactive effects of the library are:

“Particles” 220: In this case the interactive effect is produced by particles which move, reacting to the movement caused on the interactive surface; the user can modify both the parameters of the effect 221 (number, speed of movement, particle size) and the contents in terms of images 222 which form the particles (.png), background image (jpg) or video (.avi).

“Reveal” 226: this interactive effect consists of a content (picture or video) which is cancelled with a movement on the interactive surface, in order to discover an underlying content (picture or video). Also in this case the user can modify the parameters (speed of cancellation of the upper content and opacity of the cancellation effect) and the contents in terms of picture (.jpg) or video (.avi).

“Games” 223 for example “Balls”: In this case the interaction effect consists in the possibility of kicking, moving, bouncing balls, which are projected onto the interactive surface. The user can modify the parameters of number, speed of movement, size of the balls and the background content, image (jpg) or video (.avi).

“Spray”: this interaction consists in the effect similar to spray paint which is produced with a movement on the interactive surface; in this case, the user can change the colour (RGB) of the effect and the background content, image (.jpg) or video (.avi).

The library of the interactive effects is configured as an “open” system, as new effects will be released and easily integrated in it.

Once the various options offered by the scheme of FIG. 2 are selected, the changes can be recorded pushing on the “pre-set” preselecting key 230. The “pre-set” function 230 offers multiple recording possibilities of the setting parameters of the images selected from the library file 214

The following operation can require the planning of dates and times of single pre-set projections (effect+content), and relative recording 231.

The system, object of the invention, is predisposed to also operate with a function, defined “cluster” 232. In such case, it allows a defined number of projections, carried out in a synchronized way and one adjacent to the other, to create a larger interactive surface.

The statistical function allows to trace the quantity of interaction occurred for each interactive station in a predetermined (at the user's choice) time period.

The network function, allows the management, in a remote way and always through an administrator interface, of a potentially infinite number of interactive stations 10. The interactive stations can be managed, in this case, for groups or individually, being able to define, with complete freedom, real programming of contents and using all the previously described functions.

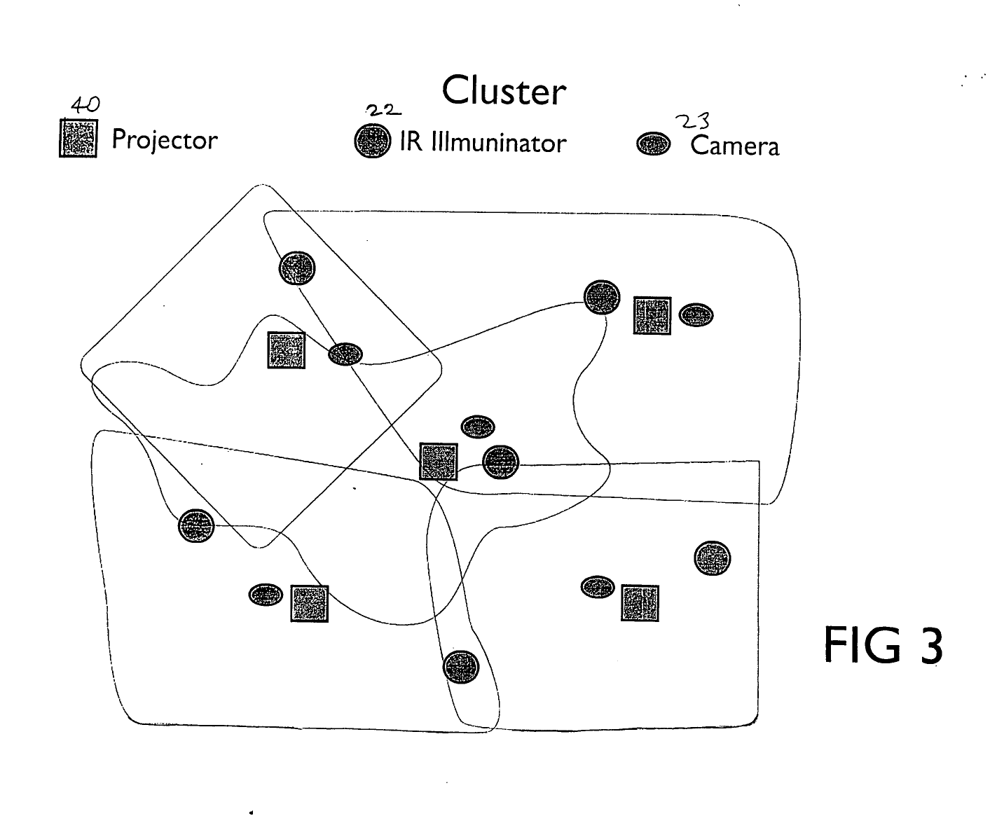

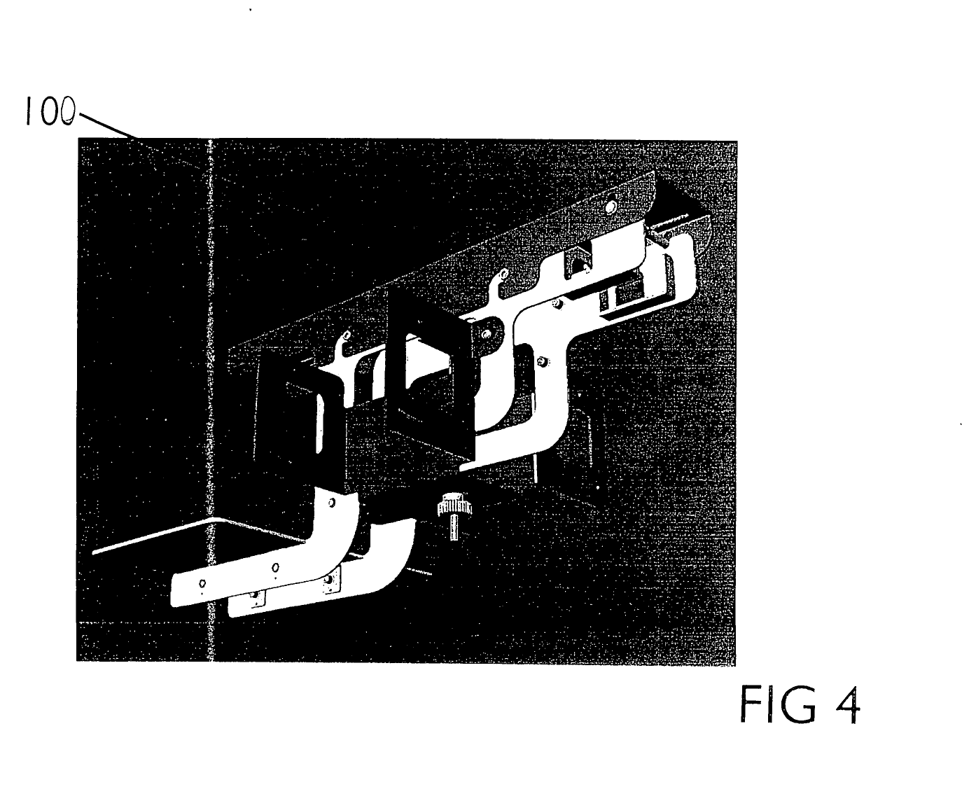

The system, object of this invention, appears particularly suitable in the provision of a complex projection surface (see FIG. 3). More particularly, the predisposition of a multitude of video cameras 23 is provided with the participation of a multitude of video projectors 40, which allow, by carrying out a partial overlapping of the projected images, the projection of complex images, the perimetrical border of which coincides with that of the definition of the object: in this way, total freedom is left in the definition of the size and shape of the interactive surface.

Finally an access key to the system is provided, called “License Admin-unlocking code” 233.

I claim:

1. A method of direct interaction between one or more subjects and at least one image and/or a video with dynamic effect projected onto an interactive surface, said method comprising the steps of:
providing a PC control unit, infra-red ray generator, a video camera, a video projector and a support for electronic devices as a direct interaction system, said PC control unit having a remote operative interface;
managing the system in stand alone or networking mode, simultaneously managing, in remote mode, different interactive stations, allowing configuration of a network of interactive station network in media channel mode;
managing a physical alignment between the projection area of the projector and the interactive surface;
selecting interactive effects from a library file and implementing said library file by acquisition of interactive effects;
tracing statistics regarding quantity of interaction with regard to each single interactive station; and
performing a cluster function, simultaneously managing different synchronized projections to create a wider interactive surface.

2. The method of direct interaction between one or more subjects and at least one image and/or a video with dynamic effect projected onto an interactive surface, according to claim 1, further comprising:
providing predisposition of a multitude of video cameras with participation of a multitude of video projectors, allowing projection of complex images and carrying out a partial overlapping of the projected images, a perimetrical border of said complex images coinciding with a definition of an object.

3. System of direct interaction between one or more subjects and at least one image and/or a video with dynamic effect projected onto an interactive surface, said system comprising:
an interactive station having an integrated apparatus for acquisition and processing of the information detected in an interactive area, and a covering shaped like a box able to be fixed onto a surface perpendicular with respect to said interactive area, wherein natural action of a person and interaction between the person and at least one image projected by a projector is carried out, wherein said interactive station incorporates a PC control unit, infra-red ray generators, at least one video camera with a firewire card and an audio outlet, and wherein at least one video projector forms part of said interactive station.
